(19) United States
(12) Patent Application Publication
(10) Pub. No.: US 2021/0035102 A1
(43) Pub. Date: Feb. 4, 2021

(54) REMITTANCE PROCESSING METHOD AND SYSTEM, AND COMPUTER-READABLE STORAGE MEDIUM

(71) Applicant: China Merchants Bank Company Limited, Shenzhen, Guangdong (CN)

(72) Inventors: Jiantao LIU, Shenzhen, Guangdong (CN); Yunfei DUAN, Shenzhen, Guangdong (CN); Wei XIN, Shenzhen, Guangdong (CN); Tingwei HOU, Shenzhen, Guangdong (CN); Jianping SUN, Shenzhen, Guangdong (CN); Zhihong LIAN, Shenzhen, Guangdong (CN)

(21) Appl. No.: 16/080,483

(22) PCT Filed: Dec. 8, 2017
(86) PCT No.: PCT/CN2017/115259

§ 371 Date: Aug. 28, 2018

(30) Foreign Application Priority Data
Jul. 19, 2017 (CN) 201710593308.5

(51) Int. Cl. G06Q 20/40; G06Q 20/42; H04L 9/06; G06Q 20/10

(52) U.S. Cl. CPC G06Q 20/407; G06Q 20/405; G06Q 20/42; H04L 2209/56; G06Q 20/108; H04L 2209/38; H04L 9/0618

(57) ABSTRACT

Provided is a remittance processing method applied to a remittance processing system including remittance processing members and a blockchain. The remittance processing method includes: receiving a remittance request instruction sent by a first remittance processing member in the remittance processing members; parsing the remittance request instruction and determining from the remittance processing members a plurality of second remittance processing members that are to process the remittance request instruction; broadcasting the remittance request instruction to the remittance processing members so that the second remittance processing members perform processing in parallel according to the remittance request instruction; and receiving and broadcasting remittance processing results sent by the second remittance processing members to the remittance processing members so that a beneficiary bank in the second remittance processing members transfers a remittance to a beneficiary according to the remittance processing results. Also provided are a remittance processing system and a computer-readable storage medium.

### FIELD OF THE DISCLOSURE

The present disclosure relates to the field of finance, and more particularly to a remittance processing method, a remittance processing system, and a computer-readable storage medium.

### BACKGROUND OF THE DISCLOSURE

In recent years, with the rapid development of China's social economy and the continuous expansion of the economic scale, the economic and trade contact between China and other countries and regions has become increasingly close, and various cross-border remittance transactions have multiplied.

However, the current cross-border remittance transaction process is a serial process. Each bank needs to wait for the previous bank to complete the processing before it can continue the processing. In addition, during the cross-border remittance process, each bank needs to reconcile records with the upstream and downstream.

Therefore, the time required for remittance processing during the cross-border remittance process is usually relatively long; sometimes it may even take several weeks. The remittance processing efficiency is relatively low, thereby affecting the customer experience.

### SUMMARY OF THE DISCLOSURE

The present disclosure is to provide a remittance processing method, a remittance processing system, and a computer-readable storage medium, which aims to achieve multi-party parallel processing of a remittance transaction, thus enhancing the customer experience.

In order to achieve the above aim, the present disclosure provides a remittance processing method applied to a remittance processing system which includes remittance processing members and a blockchain, the remittance processing method includes: receiving a remittance request instruction sent by a first remittance processing member in the remittance processing members; parsing the remittance request instruction and determining from the remittance processing members a plurality of second remittance processing members that are to process the remittance request instruction; broadcasting the remittance request instruction to the remittance processing members, allowing the plurality of second remittance processing members to perform processing in parallel according to the remittance request instruction; and receiving remittance processing results sent by the plurality of second remittance processing members, and broadcasting the remittance processing results to the remittance processing members, allowing a beneficiary bank in the plurality of second remittance processing members to transfer a remittance to a beneficiary according to the remittance processing results.

Optionally, the step of receiving the remittance processing results sent by the plurality of second remittance processing members, and broadcasting the remittance processing results to the remittance processing members, allowing the beneficiary bank to transfer the remittance to the beneficiary according to the remittance processing results includes: receiving the remittance processing results sent by the plurality of second remittance processing members; and broadcasting the remittance processing results to the remittance processing members, allowing the remittance processing members to check the remittance processing results, and the beneficiary bank transfers the remittance to the beneficiary according to the remittance processing results when the checking is passed.

Optionally, the remittance request instruction includes a remittance digital contract, the step of parsing the remittance request instruction, and determining from the remittance processing members the plurality of second remittance processing members that are to process the remittance request instruction includes: parsing the remittance request instruction to obtain the remittance digital contract; and determining from the remittance processing members the plurality of second remittance processing members that are to process the remittance request instruction based on the remittance digital contract.

In order to achieve the above aim, the present disclosure further provides a remittance processing method applied to a remittance processing system which includes remittance processing members and a blockchain, the remittance processing method includes: sending, by a first remittance processing member in the remittance processing members, a remittance request instruction to the blockchain; parsing, by the blockchain, the remittance request instruction, and determining from the remittance processing members a plurality of second remittance processing members that are to process the remittance request instruction; broadcasting, by the blockchain, the remittance request instruction to the remittance processing members, allowing the plurality of second remittance processing members to perform processing in parallel according to the remittance request instruction; and receiving, by the blockchain, the remittance processing results sent by the plurality of second remittance processing members, and broadcasting the remittance processing results to the remittance processing members, allowing a beneficiary bank in the plurality of second remittance processing members to transfer a remittance to a beneficiary according to the remittance processing results.

Optionally, the remittance request instruction includes a remittance digital contract, the step of parsing, by the blockchain, the remittance request instruction, and determining from the remittance processing members a plurality of second remittance processing members that are to process the remittance request instruction, includes: parsing, by the blockchain, the remittance request instruction to obtain the remittance digital contract; and determining, by the blockchain, the plurality of second remittance processing members that are to process the remittance request instruction from the remittance processing members, based on the remittance digital contract.

Optionally, the remittance digital contract includes at least a bank account number of a remitter, a name of the beneficiary, a bank account number of the beneficiary, a remittance route and a remittance amount, the remittance processing method further includes, subsequent to the step of parsing, by the blockchain, the remittance request instruction to obtain the remittance digital contract: checking, by the blockchain, whether the remittance route filled in the remittance digital contract is straight-through, based on a preset remittance route parameter; and modifying, by the blockchain, the remittance route according to the preset remittance route parameter when the remittance route is not straight-through, to until the remittance route is straight-through, sending, by the blockchain, a check result to the first remittance processing member, allowing the first remittance processing member to freeze in the account of the remitter an amount corresponding to the remittance amount according to the check result.

Optionally, the step of receiving, by the blockchain, the remittance processing results sent by the plurality of second remittance processing members, and broadcasting the remittance processing results to the remittance processing members, allowing the beneficiary bank to transfer the remittance to the beneficiary according to the remittance processing results, includes: receiving, by the blockchain, the remittance processing results sent by the second remittance processing members; and broadcasting, by the blockchain, the remittance processing results to the remittance processing members, allowing the remittance processing members to check the remittance processing results, and the beneficiary bank deposits an amount corresponding to the remittance amount into the bank account of the beneficiary according to the remittance processing results when the checking is passed.

Optionally, the remittance processing members access the blockchain via respective front-end systems. The step of sending, by the first remittance processing member in the remittance processing members, the remittance request instruction to the blockchain includes: sending, by the first remittance processing member in the remittance processing members, the remittance request instruction to the blockchain via a first front-end system. The step of broadcasting, by the blockchain, the remittance request instruction to the remittance processing members, allowing the plurality of second remittance processing members to perform the processing in parallel according to the remittance request instruction includes: broadcasting, by the blockchain, the remittance request instruction to the respective front-end systems of the remittance processing members , allowing the plurality of second remittance processing members to perform the processing in parallel through a plurality of corresponding second front-end systems according to the remittance request instruction. The step of receiving, by the blockchain, the remittance processing results sent by the plurality of second remittance processing members, and broadcasting the remittance processing results to the remittance processing members, allowing the beneficiary bank in the plurality of second remittance processing members to transfer the remittance to the beneficiary according to the remittance processing results includes: receiving, by the blockchain, the remittance processing results sent by the plurality of corresponding second front-end systems, and broadcasting the remittance processing results to the corresponding front-end systems of the remittance processing members, allowing the beneficiary bank in the plurality of second remittance processing members to transfer the remittance to the beneficiary according to the remittance processing results.

In addition, in order to achieve the above aim, the present disclosure also provides a remittance processing system which includes: remittance processing members, a blockchain and a remittance processing program, the remittance processing program when executed by the remittance processing members and the blockchain performing operations of the remittance processing method as described above.

In addition, in order to achieve the above aim, the present disclosure also provides a computer-readable storage medium, wherein the computer-readable storage medium stores the remittance processing program, the remittance processing program when executed by a processor performing operations of the remittance processing method as described above.

The present disclosure provides a remittance processing method, a remittance processing system, and a computer-readable storage medium. The remittance processing method is applied to the remittance processing system which includes remittance processing members and a blockchain. The remittance processing method includes: receiving a remittance request instruction sent by a first remittance processing member in the remittance processing members; parsing the remittance request instruction, and determining from the remittance processing members a plurality of second remittance processing members that are to process the remittance request instruction; broadcasting the remittance request instruction to the remittance processing members, allowing the plurality of second remittance processing members to perform processing in parallel according to the remittance request instruction; receiving remittance processing results sent by the plurality of second remittance processing members, and broadcasting the remittance processing results to the remittance processing members, allowing a beneficiary bank in the plurality of second remittance processing members to transfer a remittance to a beneficiary according to the remittance processing results. According to the above-mentioned method, the remittance processing system includes remittance processing members and a blockchain. The blockchain first receives the remittance request instruction sent by the first remittance processing member in the remittance processing members, and then parses the remittance request instruction and determines the plurality of second remittance processing members that are to process the remittance request instruction from the remittance processing members. The present disclosure is based on the decentralization and openness of the blockchain technology, and stores all the related transaction data, so that when the blockchain broadcasts the remittance request instruction to the remittance processing members, each of these remittance processing members can obtain the transaction data associated with itself from the blockchain, allowing the plurality of second remittance processing members to process the remittance request simultaneously without needing to wait for the last remittance processing member to complete the processing before they can continue the processing. Thereby, the time required for remittance processing is shortened, the remittance efficiency is improved, and so the customer experience is enhanced.

### BRIEF DESCRIPTION OF THE DRAWINGS

FIG. 1 is a schematic diagram illustrating a terminal in a hardware operating environment according to various embodiments of the present disclosure.

FIG. 2 is a schematic diagram illustrating a system architecture according to various embodiments of the present disclosure.

FIG. 3 is a flowchart illustrating a first embodiment of a remittance processing method according to the present disclosure.

FIG. 4 is a detailed flowchart illustrating the process of parsing a remittance request instruction, and determining a plurality of second remittance processing members that are to process the remittance request instruction from the remittance processing members according to various embodiments of the present disclosure.

FIG. 5 is a detailed flowchart illustrating the process of receiving remittance processing results sent by a plurality of second remittance processing members, and broadcasting the remittance processing results to the remittance processing members, allowing a beneficiary bank to transfer a remittance to a beneficiary according to the remittance processing results according to various embodiments of the present disclosure.

FIG. 6 is a flowchart illustrating a second embodiment of the remittance processing method according to the present disclosure.

FIG. 7 is a detailed flowchart illustrating the process of parsing, by a blockchain, a remittance request instruction, and determining from remittance processing members a plurality of second remittance processing members that are to process the remittance request instruction according to various embodiments of the present disclosure.

FIG. 8 is a detailed flowchart illustrating the process of receiving, by a blockchain, remittance processing results sent by a plurality of second remittance processing members, and broadcasting the remittance processing results to remittance processing members, allowing a beneficiary bank to transfer a remittance to a beneficiary according to the remittance processing results according to various embodiments of the present disclosure.

FIG. 9 is a flowchart illustrating a third embodiment of the remittance processing method according to the present disclosure.

Various implementations, functional features, and advantages of the present disclosure will now be described in further detail with reference to the accompanying drawings and some illustrative embodiments.

### DETAILED DESCRIPTION OF THE EMBODIMENTS

It is to be understood that the embodiments described herein are intended to merely illustrate and not to limit the present disclosure.

In the prior art, the process of cross-border remittance is a serial process, which means each bank needs to wait for the previous bank to complete the processing before it can continue to process. Thus, the time required for remittance processing during the cross-border remittance process is usually relatively long, resulting in a relatively low efficiency.

In order to solve the above technical problem, the present disclosure provides a remittance processing method, a remittance processing system, and a computer-readable storage medium. The remittance processing method is applied to the remittance processing system which includes remittance processing members and a blockchain. The remittance processing method includes: receiving a remittance request instruction sent by a first remittance processing member in the remittance processing members; parsing the remittance request instruction and determining from the remittance processing members a plurality of second remittance processing members that are to process the remittance request instruction; broadcasting the remittance request instruction to the remittance processing members, allowing the plurality of second remittance processing members to perform processing in parallel according to the remittance request instruction; receiving remittance processing results sent by the plurality of second remittance processing members, and broadcasting the remittance processing results to the remittance processing members, allowing a beneficiary bank in the plurality of second remittance processing members to transfer a remittance to a beneficiary according to the remittance processing results. According to the above-mentioned method, the remittance processing system includes remittance processing members and the blockchain, the blockchain first receives the remittance request instruction sent by the first remittance processing member in the remittance processing members, and then parses the remittance request instruction and determines the plurality of second remittance processing members that are to process the remittance request instruction from the remittance processing members. The present disclosure is based on the decentralization and openness of the block-chain technology, and stores all the related transaction data, so that when the blockchain broadcasts the remittance request instruction to the remittance processing members, each of these remittance processing members can obtain the transaction data associated with itself from the blockchain, allowing the plurality of second remittance processing members to process the remittance request simultaneously, without needing to wait for the previous remittance processing member to complete the processing before they can continue the processing. Thereby, the time required for remittance processing is shortened, the remittance efficiency is improved, and so the customer experience is enhanced.

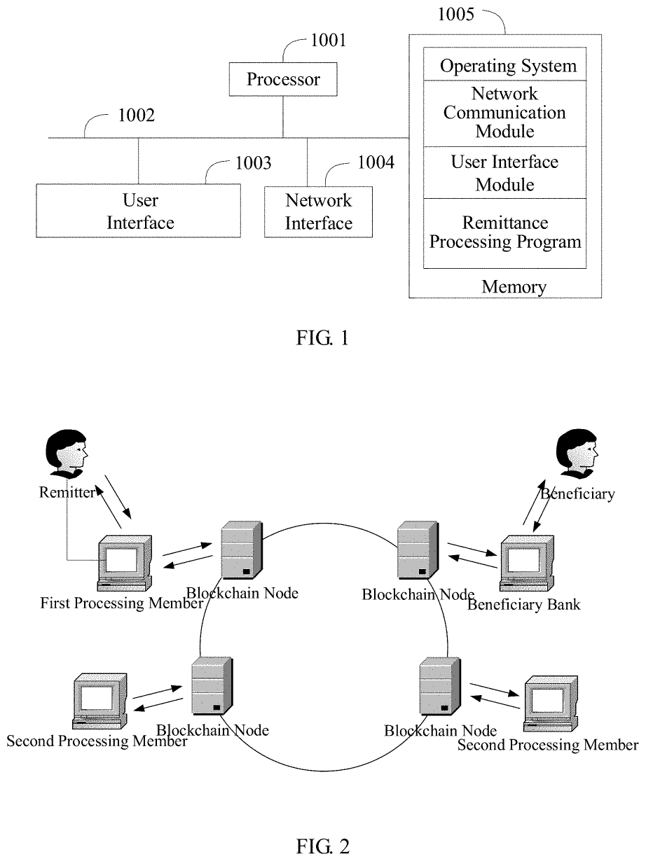

FIG. 1 is a schematic diagram illustrating a terminal in a hardware operating environment according to various embodiments of the present disclosure.

In various embodiments, the terminal may be a personal computer (PC), or may also be a mobile terminal device with display functionality, such as a smart phone, a tablet computer, or a portable computer.

As illustrated in FIG. 1, the terminal may include: a processor 1001 (e.g., a CPU), a network interface 1004, a user interface 1003, a memory 1005, and a communication bus 1002. The communication bus 1002 is configured to facilitate the connection and communication between these components. The user interface 1003 may include a display screen, an input unit such as a keyboard, and may optionally include a standard wired or wireless interface. The network interface 1004 may optionally include a standard wired or wireless interface (such as a WI-FI interface). The memory 1005 may be a high-speed RAM memory or a non-volatile memory (e.g., a magnetic disk memory). Optionally the memory 1005 may also be a storage device that is separate from the processor 1001 as described above.

Optionally, the terminal may further include a camera, a RF (Radio Frequency) circuitry, a sensor, an audio circuitry, a Wi-Fi module, and the like. The sensor may be, e.g., a light sensor, a motion sensor, or other sensors. Specifically, the light sensor may include an ambient light sensor and a proximity sensor. The ambient light sensor can adjust the brightness of the display screen according to the brightness of the ambient light. The proximity sensor can turn off the display screen and/or backlit when the mobile terminal moves near the ear. A gravity acceleration sensor, as a type of motion sensor, can detect the magnitude of acceleration in various directions (generally in three axes); it can also detect the magnitude and direction of gravity when resting, so that it can be used in applications for identifying the attitude of a mobile terminal (e.g., switching between landscape and portrait screen modes, related games, magnetometer attitude calibration), vibration identification related functions (e.g., pedometer, tapping), and so on. The mobile terminal can of course also be equipped with other sensors such as a gyroscope, a barometer, a hygrometer, a thermometer, an infrared sensor, etc.; these sensors however will not be detailed herein.

Persons skilled in the art can understand that the terminal structure illustrated in FIG. 1 is not meant to limit the terminal—the terminal may include more or fewer components than illustrated, or some components may be combined, or different component arrangements may be implemented.

As illustrated in FIG. 1, the memory 1005 as a computer storage medium may include an operating system, a network communication module, a user interface module, and a remittance processing program.

In the terminal illustrated in FIG. 1, the network interface 1004 is mainly used to connect to a backend server and perform data communication with the backend server. The user interface 1003 is mainly used to connect to a client and perform data communication with the client. The processor 1001 can be used to call the remittance processing program stored in the memory 1005 and perform the following operations: receiving a remittance request instruction sent by a first remittance processing member in the remittance processing members; parsing the remittance request instruction and determining from the remittance processing members a plurality of second remittance processing members that are to process the remittance request instruction; broadcasting the remittance request instruction to the remittance processing members, allowing the plurality of second remittance processing members to perform process in parallel according to the remittance request instruction; and receiving remittance processing results sent by the plurality of second remittance processing members, and broadcasting the remittance processing results to the remittance processing members, allowing a beneficiary bank in the plurality of second remittance processing members to transfer a remittance to a beneficiary according to the remittance processing results.

Further, the processor 1001 can call the remittance processing program stored in the memory 1005 and further perform the following operations: receiving the remittance processing results sent by the plurality of second remittance processing members, and broadcasting the remittance processing results to the remittance processing members, allowing the remittance processing members to check the remittance processing results, and the beneficiary bank transfers a remittance to the beneficiary according to the remittance processing results when the checking is passed.

Further, the processor 1001 can call the remittance processing program stored in the memory 1005 and further perform the following operations: parsing the remittance request instruction to obtain the remittance digital contract; and determining from the remittance processing members the plurality of second remittance processing members that are to process the remittance request instruction, based on the remittance digital contract.

Further, the processor 1001 can call the remittance processing program stored in the memory 1005 and further perform the following operations: sending, by a first remittance processing member in the remittance processing members, a remittance request instruction to the blockchain; parsing, by the blockchain, the remittance request instruction, and determining from the remittance processing members the plurality of second remittance processing members that are to process the remittance request instruction; broadcasting, by the blockchain, the remittance request instruction to the remittance processing members, allowing the plurality of second remittance processing members to perform processing in parallel according to the remittance request instruction; and receiving, by the blockchain, the remittance processing results sent by the plurality of second remittance processing members, and broadcasting the remittance processing results to the remittance processing members, allowing a beneficiary bank in the plurality of second remittance processing members to transfer a remittance to a beneficiary according to the remittance processing results.

Further, the processor 1001 can call the remittance processing program stored in the memory 1005 and further perform the following operations: parsing, by the blockchain, the remittance request instruction to obtain the remittance digital contract; and determining, by the blockchain, the plurality of second remittance processing members that are to process the remittance request instruction from the remittance processing members, based on the remittance digital contract.

Further, the processor 1001 can call the remittance processing program stored in the memory 1005 and further perform the following operations: checking, by the blockchain, whether the remittance route filled in the remittance digital contract is straight-through, based on a preset remittance route parameter; and modifying, by the blockchain, the remittance route according to the preset remittance route parameter when the remittance route is not straight-through, to until the remittance route is straight-through, sending, by the blockchain, a check result to the first remittance processing member, allowing the first remittance processing member to freeze in the account of the remitter an amount corresponding to the remittance amount according to the check result.

Further, the processor 1001 can call the remittance processing program stored in the memory 1005 and further perform the following operations: receiving, by the blockchain, the remittance processing result sent by the second remittance processing members; and broadcasting, by the blockchain, the remittance processing results to the remittance processing members, allowing the remittance processing members to check the remittance processing results, and the beneficiary bank deposits an amount corresponding to the remittance amount into the bank account of the beneficiary according to the remittance processing result when the checking is passed.

Further, the processor 1001 can call the remittance processing program stored in the memory 1005 and further perform the following operations: the remittance processing members access the blockchain via respective corresponding front-end systems, the step of sending, by the first remittance processing member in the remittance processing members, a remittance request instruction to the blockchain, includes: sending, by the first remittance processing member in the remittance processing members, a remittance request instruction to the blockchain via a first front-end system. The step of broadcasting, by the blockchain, the remittance request instruction to the remittance processing members, allowing the plurality of second remittance processing members to perform the processing in parallel according to the remittance request instruction, includes: broadcasting, by the blockchain, the remittance request instruction to the respective front-end systems of the remittance processing members, allowing the plurality of second remittance processing members to perform the processing in parallel through a plurality of corresponding second front-end systems according to the remittance request instruction. The step of receiving, by the blockchain, the remittance processing results sent by the plurality of second remittance processing members, and broadcasting the remittance processing results to the remittance processing members, allowing the beneficiary bank in the plurality of second remittance processing members to transfer the remittance to the beneficiary according to the remittance processing results includes: receiving, by the blockchain, the remittance processing results sent by the plurality of corresponding second front-end systems, and broadcasting the remittance processing results to the corresponding front-end systems of the remittance processing members, allowing the beneficiary bank in the plurality of second remittance processing members to transfer the remittance to the beneficiary according to the remittance processing results.

FIG. 2 is a schematic diagram illustrating a system architecture according to various embodiment of the present disclosure. The remittance processing system includes remittance processing members and a blockchain. The remittance processing members includes a first remittance processing member and a plurality of second remittance processing members. A beneficiary bank belongs to the category of second remittance processing members. The remittance processing members can have the following four cases. In a first case, a remitting bank acts as the first remittance processing member, while a correspondent bank of the remitting bank, a beneficiary bank, a correspondent bank of the beneficiary bank, as well as a multi-currency clearing system can act as the second remittance processing members. In a second case, a correspondent bank of a remitting bank acts as the first remittance processing member, while a beneficiary bank, a correspondent bank of a beneficiary bank, and a multi-currency clearing system can act as the second remittance processing members. In a third case, a remitting bank acts as the first remittance processing member, while a correspondent bank of a remitting bank, a correspondent bank of a beneficiary bank, and a multi-currency clearing system can act as the second remittance processing members. In a fourth case, a correspondent bank of a remitting bank acts as the first remittance processing member, while a correspondent bank of a beneficiary bank, and a multi-currency clearing system can act as the second remittance processing members. In addition, it should be noted that during the practical implementation process, the above four cases all may not include the multi-currency clearing system. For convenience of description, all of the embodiments of the present disclosure will be described based on the first case.

The remitting bank refers to the bank that accepts an application from a remitter and issues a remittance instruction for the remitter. When the remitting bank is not directly connected to the multi-currency clearing system, then the remittance needs to be transferred through an agent bank that has a direct connection to the multi-currency clearing system; this agent bank is the correspondent back of the remitting bank. The beneficiary bank is the beneficiary's account opening bank that makes a payment of remittance for the beneficiary. The correspondent bank of the beneficiary bank is analogous to the correspondent bank of the remitting bank, and when the beneficiary bank is not directly connected to the multi-currency clearing system, it needs to transfer the remittance through an agent bank, which is the correspondent bank of the beneficiary bank, that has a direct connection to the multi-currency clearing system. The multi-currency clearing system is a centralized clearing house that accepts remittances from various participatory banks and that completes funds settlement. The multi-currency clearing system may include a US dollar clearing system CHIPS (Clearing House Interbank Payment System), an RMB clearing System CIPS (Cross-border Interbank Payment System), etc. During the clearing process, a corresponding clearing system will be selected for settlement according to the currency of the remittance.

It should be noted that in order to ensure system security, a banking system may generally include a core system and a front-end system. The bank's core system is the bank's data processing center, which integrates the account information of bank's remitters and is the top priority in the bank's operations. The core system includes a core account processing system and a core database, and the interaction between the two can facilitate accounting information processing for various transactions. The bank's core system is a trading system that can conduct complete banking transactions and transaction processing; it is an independent and operational trading system. The front-end system is an intermediate service exchange platform that can perform message conversion, message encryption/decryption processing, communications protocol conversion, and transfer-in or transfer-out of communication messages through the routing function on this platform. Therefore, in this embodiment, to take into account the security of each banking system, each of the remitting bank, the correspondent bank of the remitting bank, the beneficiary bank, the correspondent bank of the beneficiary bank, and the multi-currency clearing system in the remittance processing system use its respective front-end system as a blockchain node to access the blockchain, or connects its front-end system to the blockchain node so as to access the blockchain.

It should also be noted that in order to ensure consensus efficiency and reduce deployment costs while ensuring the authority, neutrality, and impartiality of the cross-border remittance processing system, the quantity of blockchain nodes in principle does not exceed 50 (In fact, less than 30). Therefore, only the correspondent bank of the remitting bank, the correspondent bank of the beneficiary bank, and the multi-currency clearing system are allowed to access the blockchain through their respective front-end systems as direct participatory nodes, while the remitting bank and the beneficiary bank access the blockchain through their respective front-end systems as indirect participatory nodes.

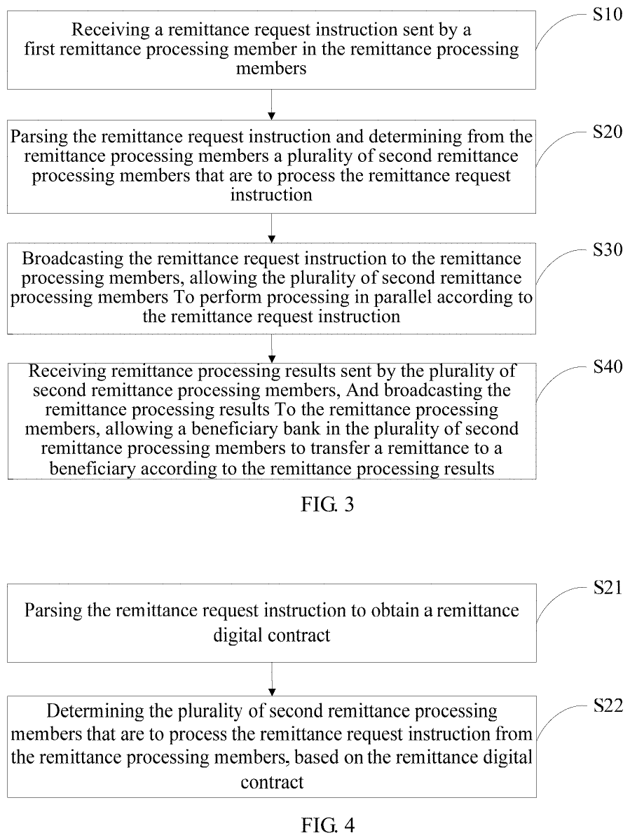

Referring to FIG. 3, FIG. 3 is a flowchart illustrating a first embodiment of the remittance processing method according to the present disclosure.

In the embodiment of the present disclosure, the remittance processing method applied to a remittance processing system which includes remittance processing members and a blockchain, the remittance processing method includes S10 and S20:

In S10, receiving a remittance request instruction sent by a first remittance processing member in the remittance processing members;

In S20, parsing the remittance request instruction, and determining from the remittance processing members a plurality of second remittance processing members that are to process the remittance request instruction.

In this embodiment, the remittance processing method is applied to the remittance processing system, which includes remittance processing members and the blockchain. The blockchain is a new mode of application of computer technologies such as distributed data storage, point-to-point transmission, consensus mechanism, encryption algorithm, and the like. It has the characteristics including decentralization, openness, autonomy, and anonymity. The remittance processing members include the first remittance processing member and the plurality of second remittance processing members.

In this embodiment, when the blockchain receives the remittance request instruction sent by the first remittance processing member, i.e., the remitting bank, the blockchain would further parse the remittance request instruction and determine the corresponding plurality of second remittance processing members that are to process the remittance request, i.e. the correspondent bank of the remitting bank, the beneficiary bank, the correspondent bank of the beneficiary bank, and the multi-currency clearing system.

The remittance request instruction may include a remittance digital contract. In this case, referring to FIG. 4 which is a detailed flowchart illustrating the process of parsing the remittance request instruction, and determining from the remittance processing members the plurality of second remittance processing members that are to process the remittance request instruction according to an embodiment of the present disclosure, block S20 includes S21 and S22.

In S21, the remittance request instruction is parsed to obtain the remittance digital contract.

In S22, the plurality of second remittance processing members that are to process the remittance request instruction are determined from the remittance processing members according to the remittance digital contract.

In the specific implementation process, the first remittance processing member, i.e., the remitting bank, needs to create a remittance digital contract according to the remittance instruction of the remitter and perform preprocessing, in addition to initiating the remittance request instruction, so as to facilitate the further processing of this cross-border remittance by the correspondent bank of the remitting bank, the beneficiary bank, the correspondent bank of the beneficiary bank, and the multi-currency clearing system. The remitter can initiate the remittance instruction through a device such as a PC or mobile terminal. Specifically, after logging on to the client, the remitter can click the remittance option and fill in the remittance information, which includes the name of remitter, the name and bank account and account opening bank of the beneficiary, the remittance currency and amount, etc., so as to trigger the remittance instruction and submit it to the corresponding remitting bank for preprocessing. The pre-processing includes: 1) Checking the information of the remitter; 2) Reviewing by a foreign exchange administration; 3) Anti money laundering; 4) Selecting the remittance route; and 5) Remittance processing. At the same time, the remitting bank would create the corresponding remittance digital contract according to the remittance instruction, and the remittance digital contract includes at least the bank account of the remitter, the name of the beneficiary, the bank account of the beneficiary, the remittance route, and the remittance amount; it certainly can also include the name and account opening bank of the remitter, the account opening bank of the beneficiary, the remittance serial number, the remittance serial number, and the currency of the remittance. In practical implementations, the remitter can also perform a cross-border payment operation through a counter terminal of a bank outlet, or an online banking terminal such as a mobile banking APP. The remittance processing method then proceeds to S30.

In S30, the remittance request instruction is broadcast to the remittance processing members, allowing the plurality of second remittance processing members to perform processing in parallel according to the remittance request instruction.

Further, the blockchain broadcasts the remittance request instruction to the remittance processing members, allowing the plurality of second remittance processing members to perform processing in parallel according to the remittance request instruction. Specifically, the processing flow by the correspondent bank of the remitting bank includes: 1) Anti money laundering; 2) Reviewing positions; 3) Supplementing the remittance route; and 4) Clearing processing. The processing flow by the multi-currency clearing system includes: 1) Anti money laundering; 2) Reviewing positions; and 3) Clearing processing. The processing flow by the correspondent bank of the beneficiary bank includes: 1) Anti money laundering; 2) Reviewing positions; and 3) Clearing processing. The processing flow by the beneficiary bank includes: 1) Anti money laundering; 2) Checking information of the beneficiary; 3) Reviewing by the foreign exchange administration; and 4) Remittance processing. Compared with the existing processing modes, this embodiment is based on the decentralized consensus mechanism of the blockchain, whereby the correspondent bank of the remitting bank, the beneficiary bank, the correspondent bank of the beneficiary bank, and the multi-currency clearing system can perform processing in parallel, which shortens the processing time and improves the efficiency. The method then continues to S40.

In S40, receiving the remittance processing results sent by the plurality of second remittance processing members, and broadcasting the remittance processing results to the remittance processing members, allowing the beneficiary bank in the second remittance processing members to transfer a remittance to the beneficiary according to the remittance processing results.

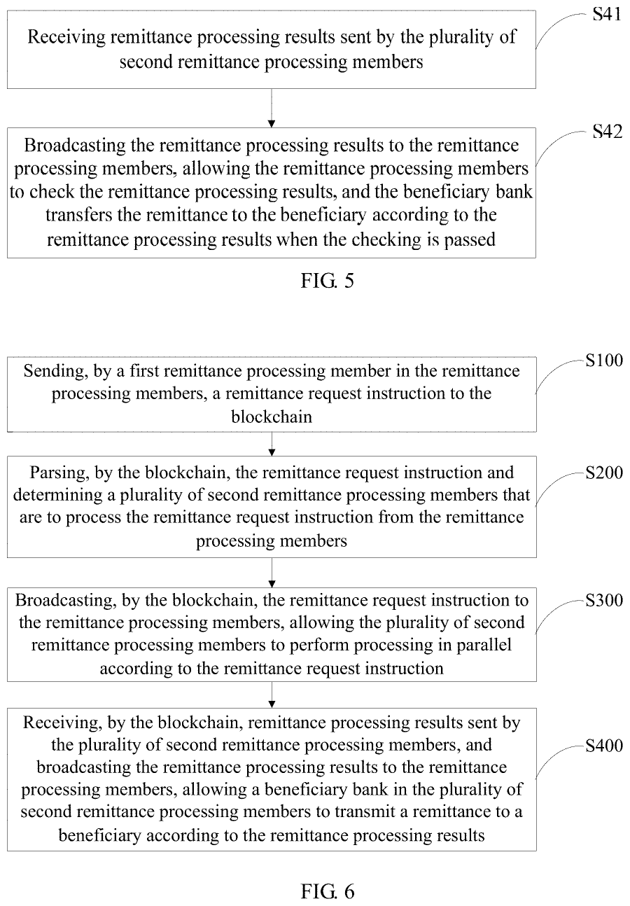

In detail, referring to FIG. 5, FIG. 5 is a detailed flowchart illustrating the process of receiving the remittance processing results sent by the plurality of second remittance processing members, and broadcasting the remittance processing results to the remittance processing members, allowing the beneficiary bank to transfer a remittance to the beneficiary according to the remittance processing results according to various embodiments of the present disclosure, block S40 includes S41 and S42:

In S41, receiving the remittance processing results sent by the plurality of second remittance processing members;

In S42, broadcasting the remittance processing results to the remittance processing members, allowing the remittance processing members to check the remittance processing results, and the beneficiary bank transfers the remittance to the beneficiary according to the remittance processing results when the checking is passed.

In this embodiment, the blockchain receives the remittance processing results sent by the plurality of second remittance processing members, and broadcasts the remittance processing results to the remittance processing members, allowing the first remittance processing member and the plurality of second remittance processing members to check the remittance processing results. When the checking is all passed, the remittance digital contract becomes effective, and so the beneficiary bank would transfer a remittance to the beneficiary according to the remittance processing results. When one of the first remittance processing member and the second remittance processing members disagrees with the remittance digital contract, then the remittance digital contract is invalid. In addition, in practical implementations, the first remittance processing member may modify or cancel the content of the remittance digital contract before the remittance digital contract becomes effective. If the remittance digital contract is modified, it can be regarded as re-initiating a remittance request instruction and the transaction needs to be re-processed.

The present disclosure provides a remittance processing method, the remittance processing method is applied to a remittance processing system which includes remittance processing members and a blockchain. The remittance processing method includes: receiving a remittance request instruction sent by a first remittance processing member of the remittance processing members; parsing the remittance request instruction and determining from the remittance processing members a plurality of second remittance processing members that are to process the remittance request instruction; broadcasting the remittance request instruction to the remittance processing members, allowing the plurality of second remittance processing members to perform processing in parallel according to the remittance request instruction; receiving remittance processing results sent by the plurality of second remittance processing members, and broadcasting the remittance processing results to the remittance processing members, allowing a beneficiary bank in the remittance processing members to transfer a remittance to a beneficiary according to the remittance processing results. According to the above method, the remittance processing system includes the remittance processing member and a blockchain. The blockchain first receives the remittance request instruction sent by the first remittance processing member in the remittance processing members, and then parses the remittance request instruction, and determines the plurality of second remittance processing members that are to process the remittance request instruction from the remittance processing members. The present disclosure is based on the decentralization and openness of the blockchain technology, and stores all the related transaction data, so that when the blockchain broadcasts the remittance request instruction to the remittance processing members, each of these remittance processing members can obtain the transaction data associated with itself from the blockchain, allowing the plurality of second remittance processing members to process the remittance request simultaneously without needing to wait for the last remittance processing member to complete the processing before they can continue the processing. Thereby, the time required for remittance processing is shortened, the remittance efficiency is improved, and so the customer experience is enhanced.

Referring to FIG. 6, FIG. 6 is a flowchart illustrating a second embodiment of the remittance processing method according to the present disclosure.

The remittance processing method is applied to a remittance processing system which includes remittance processing members and a blockchain, the remittance processing method includes S100 and S200:

In S100, sending, by a first remittance processing member in the remittance processing members, a remittance request instruction to the blockchain;

In S200, parsing, by the blockchain, the remittance request instruction, and determining from the remittance processing members a plurality of second remittance processing members that are to process the remittance request instruction;

In this embodiment, the remittance processing method is applied to the remittance processing system which includes the remittance processing members and the blockchain. In the embodiment, the blockchain is a new mode of application of computer technologies such as distributed data storage, point-to-point transmission, consensus mechanism, encryption algorithm, and the like. It has the characteristics including decentralization, openness, autonomy, and anonymity. The remittance processing members include the first remittance processing member and the plurality of second remittance processing members.

In this embodiment, when the first remittance processing member in the remittance processing members, i.e., the remittance bank, sends the remittance request instruction to the blockchain, the blockchain would further parse the remittance request instruction and determine the corresponding plurality of second remittance processing members that are to process of the remittance request instruction, i.e., the correspondent bank of remitting bank, the beneficiary bank , the correspondent bank of the beneficiary bank and the multi-currency clearing system.

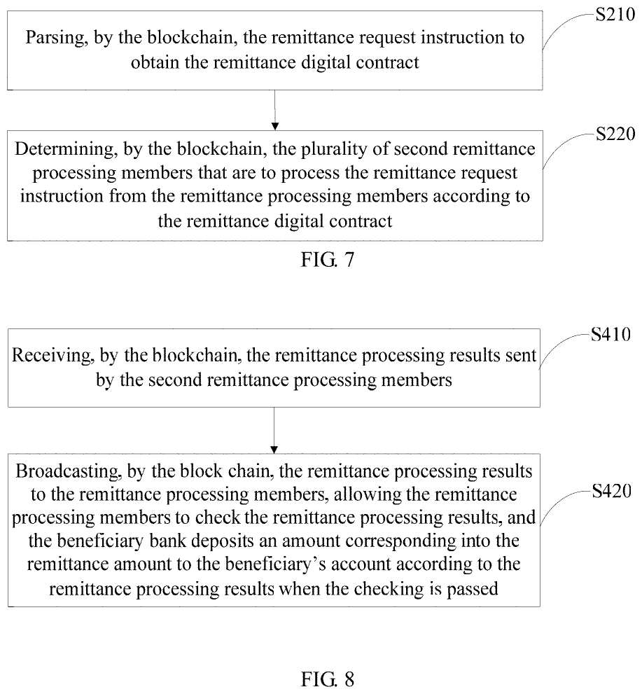

The remittance request instruction includes a remittance digital contract. Here referring to FIG. 7, FIG. 7 is a detailed flowchart illustrating the process of parsing, by a blockchain, a remittance request instruction, and determining from remittance processing members a plurality of second remittance processing members that are to process the remittance request instruction according to various embodiments of the present disclosure, block S200 includes S210 and S220:

In S210, parsing, by the blockchain, the remittance request instruction to obtain the remittance digital contract.

In S220, determining, by the blockchain, the plurality of second remittance processing members that are to process the remittance request instruction from the remittance processing members, based on the remittance digital contract.

In the practical implementations, the first remittance processing member, i.e., the remitting bank, needs to create a remittance digital contract according to the remittance instruction of the remitter and perform preprocessing, in addition to initiating the remittance request instruction, so as to facilitate the further processing of this cross-border remittance by the correspondent bank of remitting bank, the beneficiary bank, the correspondent bank of the beneficiary bank and, the multi-currency clearing system. The remitter can initiate the remittance instruction through a device such as a PC or mobile terminal. Specifically, after logging on to the client, the remitter can click the remittance option and fill in the remittance information, which includes the name of remitter, the name and, the bank account and account opening bank of the beneficiary, the remittance currency and amount, etc., so as to trigger the remittance instruction and submit it to the corresponding remitting bank for preprocessing. The pre-processing includes: 1) Checking the information of the remitter; 2) Reviewing by a foreign exchange administration; 3) Anti-money laundering; 4) Selecting the remittance route; and 5) Remittance processing. At the same time, the remitting bank would create the corresponding remittance digital contract according to the remittance instruction, and the remittance digital contract includes at least the bank account of the remitter, the name of the beneficiary, the bank account of the beneficiary, the remittance route, and the remittance amount; it certainly can also include the name and account opening bank of the remitter, the account opening bank of the beneficiary, the remittance serial number, the remittance serial number and the currency of the remittance. In practical implementations, the remitter can also perform a cross-border payment operation through a counter terminal of a bank outlet, or an online banking terminal such as a mobile banking APP. The remittance processing method then proceeds to S300.

In S300, broadcasting, by the blockchain, the remittance request instruction to the remittance processing members, allowing the plurality of second remittance processing members to perform processing in parallel according to the remittance request instruction.

Further, the blockchain broadcasts the remittance request instruction to the remittance processing members, allowing the plurality of second remittance processing members to perform processing in parallel according to the remittance request instruction. Specifically, the processing flow by the correspondent bank of the remitting bank includes: 1) Anti-money laundering; 2) Reviewing positions; 3) Supplementing the remittance route; and 4) Clearing processing. The processing flow by the multi-currency clearing system includes: 1) Anti-money laundering; 2) Reviewing positions; and 3) Clearing processing. The processing flow by the correspondent bank of the beneficiary bank includes: 1) Anti-money laundering; 2) Reviewing positions; and 3) Clearing processing. The processing flow by the beneficiary bank includes: 1) Anti-money laundering; 2) Checking information of beneficiary; 3) Reviewing by the foreign exchange administration, and 4) Remittance processing. Compared with the existing processing modes, this embodiment is based on the decentralized consensus mechanism of the blockchain, whereby the correspondent bank of the remitting bank, the beneficiary bank, the correspondent bank of the beneficiary bank and the multi-currency clearing system can perform processing in parallel, which shortens the processing time and improves the efficiency. The method then continues to S400.

In S400, receiving by the blockchain, the remittance processing results sent by the plurality of second remittance processing members, and broadcasting the remittance processing results to the remittance processing members, allowing the beneficiary bank in the second remittance processing members to transfer a remittance to the beneficiary according to the remittance processing results.

In detail, referring to FIG. 8, FIG. 8 is a detailed flowchart illustrating the process of receiving, by a blockchain, remittance processing results sent by a plurality of second remittance processing members, and broadcasting, the remittance processing results to remittance processing members, allowing a beneficiary bank to transfer a remittance to a beneficiary according to the remittance processing results according to various embodiments of the present disclosure, block S400 includes S410 and S420:

In S410, receiving, by the blockchain, the remittance processing results sent by the second remittance processing members.

In S420, broadcasting, by the blockchain, the remittance processing results to the remittance processing members, allowing the remittance processing members to check the remittance processing results, and the beneficiary bank transfers the remittance corresponding to the remittance amount to the beneficiary's bank account according to the remittance processing results when the checking is passed.

In this embodiment, when the second remittance processing members complete processing the remittance service in parallel, the blockchain receives the remittance processing results sent by the plurality of second remittance processing members, and broadcasts the remittance processing results to the remittance processing members, allowing the first remittance processing member and the plurality of second remittance processing members to check the remittance processing results. When the checking is all passed, the remittance digital contract becomes effective, and so the beneficiary bank would transfer a remittance corresponding to the remittance amount to the beneficiary's bank account according to the remittance processing results. When one of the first remittance processing member and the second remittance processing members disagrees with the remittance digital contract, then the remittance digital contract is invalid. In addition, the first remittance processing member may modify or cancel the content of the remittance digital contract before the remittance digital contract becomes effective. If the remittance digital contract is modified, it can be regarded as re-initiating a remittance request instruction and the transaction needs to be re-processed.

In addition, it should be noted that during the remittance processing process, encryption technology is employed, so that only relevant remittance processing members can obtain the remittance request instruction and transaction data associated with themselves from the blockchain, and can then perform further viewing and processing. Specifically, encryption can be performed using a hybrid encryption algorithm that combines AES (Advanced Encryption Standard) algorithm with ECC (Elliptic Curves Cryptography) algorithm. The AES algorithm can be used to encrypt and store the remittance application instruction and the remittance processing results and generate an AES key. Further, a public key of the recipient of the remittance application instruction and the remittance processing results can be obtained through the blockchain, and further used to encrypt the AES key. When receiving the remittance application instruction and the remittance processing results, a corresponding remittance processing member can use the corresponding AES key and private key for decryption, and then perform further viewing and processing, thereby ensuring the security of the transaction data. In the practical implementations, other methods may also be used for encryption, such as China's State encryption algorithms SM1, SM2, and SM3; Hash encryption algorithms SHA-1, SHA-2, and SHA-256; and so on.

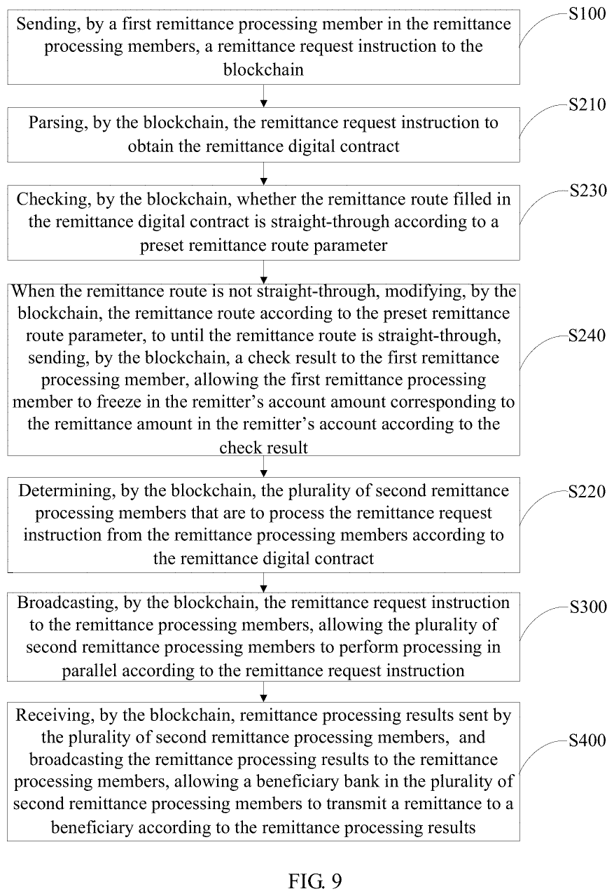

Further, referring to FIG. 9, FIG. 9 is a flowchart illustrating a third embodiment of the remittance processing method according to the present disclosure.

Based on the implement methods of FIG. 6 and FIG. 7, the remittance processing method further includes S230 and S240:

In S230, checking, by the blockchain, whether the remittance route filled in the remittance digital contract is straight-through based on a preset remittance route parameter; and

In S240, modifying, by the blockchain, the remittance route according to the preset remittance route parameter when the remittance route is not straight-through, to until the remittance route is straight-through, sending, by the blockchain, a check result to the first remittance processing member, allowing the first remittance processing member to freeze in the account of the remitter an amount corresponding to the remittance amount according to the check result.

In this embodiment, when the blockchain receives the remittance request instruction initiated by the remitting bank, the remittance route filled in the remittance digital contract is checked whether it is straight-through according to the preset remittance route parameter, it can avoid unnecessary remittance, thus improve the remittance speed, lesson the remittance fee.

Further, the blockchain would modify the remittance route according to the preset remittance route parameter when the remittance route is not straight-through, to until the remittance route is straight-through, the blockchain sends the check result to the first remittance processing member, i.e. the remitting bank, allowing the remitting bank to freeze in the account of the remitter an amount corresponding to the remittance amount according to the check result. In the specific embodiment, when the blockchain is incapable to modify the remittance route, then the remittance digital contract would be returned back to the remitting bank, making the remitting bank to re-choose remittance route.

The present disclosure further provides a computer-readable storage medium having stored therein a remittance processing program. The remittance processing program when executed by a processor, performs the steps of the remittance processing methods as described above.

Embodiments of the computer-readable storage medium disclosed herein are substantially the same as the various embodiments of the remittance processing methods describe supra, and so they are not to be detailed herein again.

It should be appreciated that, throughout this disclosure, the terms “include”, “including” or any other variations thereof are intended to compass non-exclusive inclusions, so that a process, method, article, or system that includes a series of elements would include not only those elements, but it may further include other elements that are not explicitly listed or elements that are inherent to such processes, methods, articles, or systems. In the absence of extra limitations, an element defined by the phrase “includes a . . . ” does not exclude the presence of additional identical elements in this process, method, article, or system that includes the element.

Sequence numbers of the embodiments disclosed herein are meant for the sole purpose of illustrative and do not represent the advantages and disadvantages of these embodiments.

Through the above description of the foregoing embodiments, those skilled in the art can clearly understand that the above methods of the embodiments can be implemented by means of software plus a necessary general hardware platform; they certainly can also be implemented by means of hardware, but in many cases, the former is a better implementation. Based on this understanding, the essential part of the technical solution according to the present disclosure or the part that contributes to the prior art can be embodied in the form of a software product. Computer software products can be stored in a storage medium as described above (e.g., ROM/RAM, a magnetic disk, an optical disc) which includes instructions to cause a terminal device (e.g., a mobile phone, a computer, a server, an air conditioner, or a network device, etc.) to perform the methods described in the various embodiments of the present disclosure.

The foregoing embodiments are merely some illustrative embodiments of the present disclosure, and are not intended to limit the patentable scope of the present disclosure,. Any equivalent structural or flow transformations based on the specification and the drawing of the present disclosure, or any direct or indirect applications of the present disclosure in other related technical fields, shall all fall within the protection scope of the present disclosure.

What is claimed is:

1. A remittance processing method, applied to a remittance processing system which comprises remittance processing members and a blockchain, the remittance processing method comprising:
receiving a remittance request instruction sent by a first remittance processing member in the remittance processing members;
parsing the remittance request instruction, and determining from the remittance processing members a plurality of second remittance processing members that are to process the remittance request instruction;
broadcasting the remittance request instruction to the remittance processing members, allowing the plurality of second remittance processing members to perform processing in parallel according to the remittance request instruction; and
receiving remittance processing results sent by the plurality of second remittance processing members, and broadcasting the remittance processing results to the remittance processing members, allowing a beneficiary bank in the plurality of second remittance processing members to transfer a remittance to a beneficiary according to the remittance processing results.

2. The remittance processing method according to claim 1, wherein the step of receiving the remittance processing results sent by the plurality of second remittance processing members, and broadcasting the remittance processing results to the remittance processing members, allowing the beneficiary bank to transfer the remittance to the beneficiary according to the remittance processing results comprises:
receiving the remittance processing results sent by the plurality of second remittance processing members; and
broadcasting the remittance processing results to the remittance processing members, allowing the remittance processing members to check the remittance processing results, and the beneficiary bank transfers the remittance to the beneficiary according to the remittance processing results when the checking is passed.

3. The remittance processing method according to claim 1, wherein the remittance request instruction comprises a remittance digital contract, and the step of parsing the remittance request instruction, and determining from the remittance processing members the plurality of second remittance processing members that are to process the remittance request instruction comprises:
parsing the remittance request instruction, to obtain the remittance digital contract; and
determining from the remittance processing members the plurality of second remittance processing members that are to process the remittance request instruction, based on the remittance digital contract.

4. A remittance processing method, applied to a remittance processing system which comprises remittance processing members and a blockchain, the remittance processing method comprising:
sending, by a first remittance processing member in the remittance processing members, a remittance request instruction to the blockchain;
parsing, by the blockchain, the remittance request instruction, and determining from the remittance processing members a plurality of second remittance processing members that are to process the remittance request instruction;
broadcasting, by the blockchain, the remittance request instruction to the remittance processing members, allowing the plurality of second remittance processing members to perform processing in parallel according to the remittance request instruction;
receiving, by the blockchain, the remittance processing results sent by the plurality of second remittance processing members, and broadcasting the remittance processing results to the remittance processing members, allowing a beneficiary bank in the plurality of second remittance processing members to transfer a remittance to a beneficiary according to the remittance processing results.

5. The remittance processing method according to claim 4, wherein the remittance request instruction comprises a remittance digital contract, and the step of parsing, by the blockchain, the remittance request instruction, and determining from the remittance processing members a plurality of second remittance processing members that are to process the remittance request instruction, comprises:
parsing, by the blockchain, the remittance request instruction to obtain the remittance digital contract; and
determining, by the blockchain, the plurality of second remittance processing members that are to process the remittance request instruction from the remittance processing members, based on the remittance digital contract.

6. The remittance processing method according to claim 5, wherein the remittance digital contract comprises at least a bank account number of a remitter, a name of the beneficiary, a bank account number of the beneficiary, a remittance route, and a remittance amount, and the remittance processing method further comprises, subsequent to the step of parsing, by the blockchain, the remittance request instruction to obtain the remittance digital contract:
checking, by the blockchain, whether the remittance route filled in the remittance digital contract is straight-through, based on a preset remittance route parameter; and
modifying, by the blockchain, the remittance route according to the preset remittance route parameter when the remittance route is not straight-through, to until the remittance route is straight-through, sending, by the blockchain, a check result to the first remittance processing member, allowing the first remittance processing member to freeze in the account of the remitter an amount corresponding to the remittance amount according to the check result.

7. The remittance processing method according to claim 6, wherein the step of receiving, by the blockchain, the remittance processing results sent by the plurality of second remittance processing members, and broadcasting the remittance processing results to the remittance processing members, allowing the beneficiary bank to transfer the remittance to the beneficiary according to the remittance processing results, comprises:
receiving, by the blockchain, the remittance processing results sent by the second remittance processing members; and
broadcasting, by the blockchain, the remittance processing results to the remittance processing members, allowing the remittance processing members to check the remittance processing results, and the beneficiary bank deposits an amount corresponding to the remittance amount into the bank account of the beneficiary according to the remittance processing results when the checking is passed.

8. The remittance processing method according to claim 4, wherein the remittance processing members access the blockchain via respective front-end systems, and the step of sending, by the first remittance processing member in the remittance processing members, the remittance request instruction to the blockchain, comprises:
sending, by the first remittance processing member in the remittance processing members, the remittance request instruction to the blockchain via a first front-end system;
and the step of broadcasting, by the blockchain, the remittance request instruction to the remittance processing members, allowing the plurality of second remittance processing members to perform the processing in parallel according to the remittance request instruction, comprises:
broadcasting, by the blockchain, the remittance request instruction to the respective front-end systems of the remittance processing members, allowing the plurality of second remittance processing members to perform the processing in parallel through a plurality of corresponding second front-end systems according to the remittance request instruction;
and the step of receiving, by the blockchain, the remittance processing results sent by the plurality of second remittance processing members, and broadcasting the remittance processing results to the remittance processing members, allowing the beneficiary bank in the plurality of second remittance processing members to transfer the remittance to the beneficiary according to the remittance processing results, comprises:
receiving, by the blockchain, the remittance processing results sent by the plurality of corresponding second front-end systems, and broadcasting the remittance processing results to the corresponding front-end systems of the remittance processing members, allowing the beneficiary bank in the plurality of second remittance processing members to transfer the remittance to the beneficiary according to the remittance processing results.

9. The remittance processing method according to claim 5, wherein the remittance processing members access the blockchain via respective front-end systems, and the step of sending, by the first remittance processing member in the remittance processing members, the remittance request instruction to the blockchain comprises:
sending, by the first remittance processing member in the remittance processing members, the remittance request instruction to the blockchain via a first front-end system;
and the step of broadcasting, by the blockchain, the remittance request instruction to the remittance processing members, allowing the plurality of second remittance processing members to perform the processing in parallel according to the remittance request instruction, comprises:
broadcasting, by the blockchain, the remittance request instruction to the respective front-end systems of the remittance processing members, allowing the plurality of second remittance processing members to perform the processing in parallel through a plurality of corresponding second front-end systems according to the remittance request instruction;
and the step of receiving, by the blockchain, the remittance processing results sent by the plurality of second remittance processing members, and broadcasting the remittance processing results to the remittance processing members, allowing the beneficiary bank in the plurality of second remittance processing members to transfer the remittance to the beneficiary according to the remittance processing results, comprises:
receiving, by the blockchain, the remittance processing results sent by the plurality of corresponding second front-end systems, and broadcasting the remittance processing results to the corresponding front-end systems of the remittance processing members, allowing the beneficiary bank in the plurality of second remittance processing members to transfer the remittance to the beneficiary according to the remittance processing results.

10. The remittance processing method according to claim 6, wherein the remittance processing members access the blockchain via respective front-end systems, and the step of sending, by the first remittance processing member in the remittance processing members, the remittance request instruction to the blockchain, comprises:
sending, by the first remittance processing member in the remittance processing members, the remittance request instruction to the blockchain via a first front-end system;
and the step of broadcasting, by the blockchain, the remittance request instruction to the remittance processing members, allowing the plurality of second remittance processing members to perform the processing in parallel according to the remittance request instruction, comprises:
broadcasting, by the blockchain, the remittance request instruction to the respective front-end systems of the remittance processing members, allowing the plurality of second remittance processing members to perform the processing in parallel through a plurality of corresponding second front-end systems according to the remittance request instruction;
and the step of receiving, by the blockchain, the remittance processing results sent by the plurality of second remittance processing members, and broadcasting the remittance processing results to the remittance processing members, allowing the beneficiary bank in the plurality of second remittance processing members to transfer the remittance to the beneficiary according to the remittance processing results, comprises:
receiving, by the blockchain, the remittance processing results sent by the plurality of corresponding second front-end systems, and broadcasting the remittance processing results to the corresponding front-end systems of the remittance processing members, allowing the beneficiary bank in the plurality of second remittance processing members to transfer the remittance to the beneficiary according to the remittance processing results.

11. The remittance processing method according to claim 7, wherein the remittance processing members access the blockchain via respective front-end systems, and the step of sending, by the first remittance processing member in the remittance processing members, the remittance request instruction to the blockchain comprises:
sending, by the first remittance processing member in the remittance processing members, the remittance request instruction to the blockchain via a first front-end system;
and the step of broadcasting, by the blockchain, the remittance request instruction to the remittance processing members, allowing the plurality of second remittance processing members to perform the processing in parallel according to the remittance request instruction comprises:
broadcasting, by the blockchain, the remittance request instruction to the respective front-end systems of the remittance processing members, allowing the plurality of second remittance processing members to perform the processing in parallel through a plurality of corresponding second front-end systems according to the remittance request instruction;
and the step of receiving, by the blockchain, the remittance processing results sent by the plurality of second remittance processing members, and broadcasting the remittance processing results to the remittance processing members, allowing the beneficiary bank in the plurality of second remittance processing members to transfer the remittance to the beneficiary according to the remittance processing results, comprises:
receiving, by the blockchain, the remittance processing results sent by the plurality of corresponding second front-end systems, and broadcasting the remittance processing results to the corresponding front-end systems of the remittance processing members, allowing the beneficiary bank in the plurality of second remittance processing members to transfer the remittance to the beneficiary according to the remittance processing results.

12. A remittance processing system, comprising remittance processing members, a blockchain, and a remittance processing program, the remittance processing program when executed by the remittance processing members and the blockchain performing the following operations:
sending, by a first remittance processing member in the remittance processing members, a remittance request instruction to the blockchain;
parsing, by the blockchain, the remittance request instruction, and determining from the remittance processing members a plurality of second remittance processing members that are to process the remittance request instruction;
broadcasting, by the blockchain, the remittance request instruction to the remittance processing members, allowing the plurality of second remittance processing members to perform processing in parallel according to the remittance request instruction; and
receiving, by the blockchain, the remittance processing results sent by the plurality of second remittance processing members, and broadcasting the remittance processing results to the remittance processing members, allowing a beneficiary bank in the plurality of second remittance processing members to transfer a remittance to a beneficiary according to the remittance processing results.

13. The remittance processing system according to claim 12, wherein the remittance processing program when executed by the remittance processing members and the blockchain further performs the following operations:
parsing, by the blockchain, the remittance request instruction to obtain the remittance digital contract; and
determining, by the blockchain, the plurality of second remittance processing members that are to process the remittance request instruction from the remittance processing members, based on the remittance digital contract.

14. The remittance processing system according to claim 13, wherein the remittance processing program when executed by the remittance processing members and the blockchain further performs the following operations:
checking, by the blockchain, whether the remittance route filled in the remittance digital contract is straight-through, based on a preset remittance route parameter; and
modifying, by the blockchain, the remittance route according to the preset remittance route parameter when the remittance route is not straight-through, to until the remittance route is straight-through, sending, by the blockchain, a check result to the first remittance processing member, allowing the first remittance processing member to freeze in the account of the remitter an amount corresponding to the remittance amount according to the check result.

15. The remittance processing system according to claim 14, wherein the remittance processing program when executed by the remittance processing members and the blockchain further performs the following operations:
receiving, by the blockchain, the remittance processing results sent by the second remittance processing members; and
broadcasting, by the blockchain, the remittance processing results to the remittance processing members, allowing the remittance processing members to check the remittance processing results, and the beneficiary bank deposits an amount corresponding to the remittance amount to the bank account of the beneficiary according to the remittance processing results when the checking is passed.

16. The remittance processing system according to claim 12, wherein the remittance processing program when executed by the remittance processing members and the blockchain further performs the following operations:
the step of sending, by the first remittance processing member in the remittance processing members, the remittance request instruction to the blockchain, comprises:
sending, by the first remittance processing member in the remittance processing members, the remittance request instruction to the blockchain via a first front-end system;
and the step of broadcasting, by the blockchain, the remittance request instruction to the remittance processing members, allowing the plurality of second remittance processing members to perform the processing in parallel according to the remittance request instruction, comprises:
broadcasting, by the blockchain, the remittance request instruction to the respective front-end systems of the remittance processing members, allowing the plurality of second remittance processing members to perform the processing in parallel through a plurality of corresponding second front-end systems according to the remittance request instruction;
and the step of receiving, by the blockchain, the remittance processing results sent by the plurality of second remittance processing members, and broadcasting the remittance processing results to the remittance processing members, allowing the beneficiary bank in the plurality of second remittance processing members to transfer the remittance to the beneficiary according to the remittance processing results, comprises:
receiving, by the blockchain, the remittance processing results sent by the plurality of corresponding second front-end systems, and broadcasting the remittance processing results to the corresponding front-end systems of the remittance processing members, allowing the beneficiary bank in the plurality of second remittance processing members to transfer the remittance to the beneficiary according to the remittance processing results.

17-21. (canceled)
